(19) United States
(12) Patent Application Publication
(10) Pub. No.: US 2024/0225211 A1
(43) Pub. Date: Jul. 11, 2024

(54) Watchband and Watch

(71) Applicant: Huawei Technologies Co., Ltd., Shenzhen (CN)

(72) Inventors: Hehui Yang, Dongguan (CN); Zhicong Xie, Shenzhen (CN); Junyu Chen, Dongguan (CN)

(21) Appl. No.: 18/613,660

(22) Filed: Mar. 22, 2024

Related U.S. Application Data
(63) Continuation of application No. PCT/CN2022/119711, filed on Sep. 19, 2022.

(30) Foreign Application Priority Data
Sep. 28, 2021 (CN) 202111143109.7

(51) Int. Cl. A44C 5/20; A44C 5/00

(52) U.S. Cl. CPC A44C 5/2071; A44C 5/0007

(57) ABSTRACT

A watchband includes a first watch clasp, a second watch clasp, a first band body, and a second band body. An accommodating space is provided in the first watch clasp, and the accommodating space is used to accommodate an electronic device. The second watch clasp is detachably connected to the first watch clasp. One end of the first band body is connected to the first watch clasp, and is configured to be electrically connected to the electronic device. One end of the second band body is connected to the second watch clasp.

### CROSS-REFERENCE TO RELATED APPLICATIONS

This is a continuation of International Patent Application No. PCT/CN2022/119711 filed on Sep. 19, 2022, which claims priority to Chinese Patent Application No. 202111143109.7 filed on Sep. 28, 2021. The disclosures of the aforementioned applications are hereby incorporated by reference in their entireties.

### TECHNICAL FIELD

This disclosure relates to the field of electronic devices, and in particular, to a watchband and a watch.

### BACKGROUND

A smartwatch is an electronic watch. In addition to a timing function of other watches, the smartwatch has a plurality of other functions, such as communication, navigation, and body monitoring.

In a related technology, the smartwatch mainly includes a watch face and a watchband. An electronic device is disposed in the watch face, to implement various functions of the smartwatch. The watchband is connected to the watch face, so that the smartwatch can be bound to a wrist of a user.

However, currently, the watchband has a single function, which is not conducive to function extension of the smartwatch.

### SUMMARY

Embodiments of this disclosure provide a watchband and a watch, to resolve a problem that is not conducive to function extension of a smartwatch. The technical solutions are as follows:

According to a first aspect, a watchband is provided, and can be used in a watch. The watchband includes a first watch clasp, a second watch clasp, a first band body, and a second band body. An accommodating space is provided in the first watch clasp, and the accommodating space is used to accommodate an electronic device. This is equivalent to providing a mounting space for the electronic device. One end of the first band body is connected to the first watch clasp, and is configured to be electrically connected to the electronic device. The other end of the first band body is configured to be connected to a watch face of a watch, and can be electrically connected. Therefore, the electronic device is electrically connected to the watch face through the first band body. Various electronic devices are configured in the accommodating space, to extend a function of the watch, so that functionality of the watch is improved. One end of the second band body is connected to the second watch clasp, and the other end of the second band body is configured to be connected to the watch face. The second watch clasp is detachably connected to the first watch clasp, so that the watchband can be worn.

The watchband provided in this embodiment of this disclosure has at least the following effect:

The watchband is used in the watch. Because the accommodating space is provided in the first watch clasp, the various electronic devices can be configured in the accommodating space, to extend the function of the watch, so that functionality of the watch is improved.

In an example embodiment, the first watch clasp includes a first housing and a first cover. The first housing is an open housing-shaped mechanical component. A boss is disposed on an inner bottom surface of the first housing. A top of the boss faces an opening of the first housing. A groove is provided on a part that is of the boss and that is away from the inner bottom surface of the first housing, that is, the groove is located on the top of the boss. The first cover is located at the opening of the first housing. The first cover is connected to the boss, and covers a groove opening of the groove, to form the accommodating space between the first cover and the groove. In other words, the accommodating space is formed by covering the first cover on the groove opening of the groove. The accommodating space is located between the first cover and the first housing.

In an example embodiment, a sealing groove is provided around the groove. The first watch clasp further includes a sealing component. The sealing component is located in the sealing groove, and is clamped between the first cover and the boss. In this design, a gap between the first cover and the boss can be sealed through the sealing component, to avoid an impact on the electronic device in the accommodating space caused by dust, liquid, or the like entering the accommodating space.

In an example embodiment, a lock slot is provided on an outer wall of the second watch clasp. The first watch clasp further includes a lock clasp. A first part of the lock clasp is inserted into the first housing and is located on one side of the boss. A second part of the lock clasp is located outside the first housing and is inserted into the lock slot. The lock clasp can move relative to the first housing. In a process of moving the second part of the lock clasp in the lock slot, the lock clasp and the lock slot can be locked or unlocked. In other words, the lock clasp is disposed on the first watch clasp, and the lock slot is provided on the second watch clasp. A detachable connection between the first clasp and the second watch clasp is implemented through fitting between the lock clasp and the lock slot.

In an example embodiment, the lock clasp includes a first sliding block and a first lock arm. A first part of the first sliding block is located in the first housing, and can move relative to the first housing. A second part of the first sliding block is located outside the first housing, and can drive the entire first sliding block to move together. A first part of the first lock arm is connected to the first part of the first sliding block, and is located on a side that is of the first sliding block and that is away from the inner bottom surface of the first housing. A second part of the first lock arm is located outside the first housing. Because the first part of the first lock arm is connected to the first sliding block, the first lock arm can move together by driving the first sliding block. A first notch is provided on a side wall of the second part of the first lock arm, and the first notch is configured to fit a first protrusion. The first protrusion is located on an inner side wall of the lock slot, and is located at a slot opening of the lock slot. The first protrusion faces the first notch. When the first sliding block drives the second part of the first lock arm to move away from a center of the second watch clasp, and the first protrusion is located in the first notch, the lock clasp and the lock slot are mutually locked. When the first sliding block drives the second part of the first lock arm to move toward the center of the second watch clasp, and the first protrusion is located outside the first notch, the lock clasp and the lock slot are mutually unlocked.

In an example embodiment, a first inclined surface is provided on a side that is of the first protrusion and that is close to the slot opening of the lock slot. In a direction toward the center of the second watch clasp, the first inclined surface tilts from the slot opening of the lock slot to a slot bottom. In this design, in the process of inserting the lock clasp into the lock slot, a top of the lock clasp abuts against the first inclined surface, and moves along the first inclined surface, to avoid the first protrusion. In this way, the lock clasp is gradually inserted into the lock slot, and the process of inserting the lock clasp into the lock slot is smoother.

In an example embodiment, a second inclined surface is further provided on the inner side wall of the lock slot. The second inclined surface faces the first inclined surface. In the direction toward the center of the second watch clasp, the second inclined surface tilts from the slot bottom of the lock slot to the slot opening. In this design, in the process of pulling the lock clasp out of the lock slot, the lock clasp moves away from the center of the second watch clasp, so that the top of the lock clasp abuts against the second inclined surface. The lock clasp is pushed out of the lock slot under an action of the second inclined surface, so that the process of pulling the lock clasp out of the lock slot is smoother.

In an example embodiment, the first watch clasp further includes a first elastic component. The first elastic component is located in the first housing, and is compressed between the second part of the lock clasp and the boss. An elastic direction of the first elastic component is the same as a moving direction of the lock clasp. In other words, the first elastic component can apply one acting force to move the lock clasp away from the center of the second watch clasp. In this design, when the lock clasp is in an initial state, under an action of the first elastic component, the lock clasp is located at a position away from the center of the second watch clasp. In the process of inserting the lock clasp into the lock slot, the lock clasp moves toward the center of the second watch clasp under an action of the first inclined surface, and compresses the first elastic component, to avoid the first protrusion. After the first protrusion is avoided, elastic potential energy of the first elastic component is released, to push back the lock clasp away from the center of the second watch clasp. In this case, the first protrusion is inserted into the first notch, so that the lock clasp and the lock slot are locked. In the process of pulling the lock clasp out of the lock slot, the lock clasp moves toward the center of the second watch clasp, and compresses the first elastic component. The lock clasp is pushed out of the lock slot under the action of the second inclined surface, so that the lock clasp and the lock slot are unlocked. After the lock slot is pulled out of the lock slot, the elastic potential energy of the first elastic component is released, to move the lock clasp away from the center of the second watch clasp.

In an example embodiment, the lock clasp includes a drive block, a second sliding block, and a second lock arm. A first part of the drive block is located in the first housing, and can move relative to the first housing. A second part of the drive block is located outside the first housing, and can drive the entire drive block to move together. The second sliding block is inserted into the first housing, and can move relative to the first housing. The second sliding block is in sliding contact with the drive block, and an included angle exists between a moving direction of the second sliding block and a moving direction of the drive block. Therefore, the drive block also pushes the second sliding block to move together when the drive block moves. A first part of the second lock arm is located in the first housing, and is connected to the second sliding block. A second part of the second lock arm is located outside the first housing. Because the first part of the second lock arm is connected to the second sliding block, the second lock arm can move together by driving the second sliding block. A second notch is provided on a side wall of the second part of the second lock arm, and the second notch is configured to fit a second protrusion. The second protrusion is located on the inner side wall of the lock slot, and is located at the slot opening of the lock slot. The second protrusion faces the second notch. When the drive block drives the second sliding block to move the second part of the second lock arm toward the center of the second watch clasp, and the second protrusion is located in the second notch, the lock clasp and the lock slot are mutually locked. When the second sliding block drives the second part of the second lock arm to move away from the center of the second watch clasp, and the second protrusion is located outside the second notch, the lock clasp and the lock slot are mutually unlocked.

In an example embodiment, a third inclined surface is provided on a side that is of the second protrusion and that is close to the slot opening of the lock slot. In a direction away from the center of the second watch clasp, the third inclined surface tilts from the slot opening of the lock slot to the slot bottom. In this design, in the process of inserting the lock clasp into the lock slot, the top of the lock clasp abuts against the third inclined surface, and moves along the third inclined surface, to avoid the second protrusion. In this way, the lock clasp is gradually inserted into the lock slot, and the process of inserting the lock clasp into the lock slot is smoother.

In an example embodiment, a fourth inclined surface is further provided on the inner side wall of the lock slot. The fourth inclined surface faces the third inclined surface. In the direction away from the center of the second watch clasp, the fourth inclined surface tilts from the slot bottom of the lock slot to the slot opening. In this design, in the process of pulling the lock clasp out of the lock slot, the lock clasp moves away from the center of the second watch clasp, so that the top of the lock clasp abuts against the fourth inclined surface. The lock clasp is pushed out of the lock slot under an action of the fourth inclined surface, so that the process of pulling the lock clasp out of the lock slot is smoother.

In an example embodiment, the first watch clasp further includes a second elastic component. The second elastic component is located in the first housing, and is compressed between the second part of the lock clasp and an inner side wall of the first housing. An elastic direction of the second elastic component is the same as a moving direction of the lock clasp. In other words, the second elastic component can apply one acting force to move the lock clasp toward the center of the second watch clasp. In the process of inserting the lock clasp into the lock slot, the lock clasp moves away from a center of a second housing under an action of the third inclined surface, and compresses the second elastic component, to avoid the second protrusion. After the second protrusion is avoided, elastic potential energy of the second elastic component is released, to move the lock clasp toward the center of the second watch clasp. In this case, the second protrusion is inserted into the second notch, so that the lock clasp and the lock slot are locked. In the process of pulling the lock clasp out of the lock slot, the lock clasp moves away from the center of the second watch clasp, and compresses the second elastic component. The lock clasp is pushed out of the lock slot under the action of the fourth inclined surface, so that the lock clasp and the lock slot are unlocked. After the lock slot is pulled out of the lock slot, the elastic potential energy of the second elastic component is released, to push back the lock clasp toward the center of the second watch clasp.

In an example embodiment, a first magnetic component is disposed in the first watch clasp. A second magnetic component is disposed in the second watch clasp, and the second magnetic component and the first magnetic component are attracted to each other. In this design, when the first watch clasp is fastened to the second watch clasp, the first magnetic component and the second magnetic component are attracted to each other. Under effect of this magnetic force, the first watch clasp and the second watch clasp move toward each other, and are mutually locked through fitting between the lock clasp and the lock slot.

According to a second aspect, a watch is provided. The watch includes a watch face, a watchband, and an electronic device. The watchband is the watchband described above. One end of a first band body is connected to a first watch clasp. One end that is of the first band body and that is away from the first watch clasp is connected to the watch face. One end of a second band body is connected to a second watch clasp. One end that is of the second band body and that is away from the second watch clasp is connected to the watch face. The electronic device is located in an accommodating space in the first watch clasp. The electronic device is electrically connected to the watch face through the first band body.

The watch provided in this embodiment of this disclosure has at least the following effect:

Because various electronic devices can be accommodated in the first watch clasp of the watchband, the watch can correspondingly have a plurality of different functions based on different electronic devices, to extend the function of the watch, so that functionality of the watch is improved.

### BRIEF DESCRIPTION OF DRAWINGS

FIG. 1 is a schematic diagram of a structure of a watchband according to an embodiment of this disclosure;

FIG. 2 is a sectional view of FIG. 1 in a direction A-A according to an embodiment of this disclosure;

FIG. 3 is a schematic diagram of a structure of a first watch clasp according to an embodiment of this disclosure;

FIG. 4 is an exploded view of a first watch clasp according to an embodiment of this disclosure;

FIG. 5 is a schematic diagram of a structure of a first watch clasp according to an embodiment of this disclosure;

FIG. 6 is a schematic diagram of a disassembled state and an assembled state between a first watch clasp and a second watch clasp according to an embodiment of this disclosure;

FIG. 7 is a schematic diagram of a locked state between a lock clasp and a lock slot according to an embodiment of this disclosure;

FIG. 8 is a schematic diagram of an unlocked state between a lock clasp and a lock slot according to an embodiment of this disclosure;

FIG. 9 is a schematic diagram of assembly of a lock clasp according to an embodiment of this disclosure;

FIG. 10 is a schematic diagram of an assembly process between a first watch clasp and a second watch clasp according to an embodiment of this disclosure;

FIG. 11 is a schematic diagram of a disassembly process between a first watch clasp and a second watch clasp according to an embodiment of this disclosure;

FIG. 12 is a second fitting manner between a lock clasp and a lock slot according to an embodiment of this disclosure;

FIG. 13 is a schematic diagram of a locked state between a lock clasp and a lock slot according to an embodiment of this disclosure;

FIG. 14 is a schematic diagram of an unlocked state between a lock clasp and a lock slot according to an embodiment of this disclosure;

FIG. 15 is an exploded view of a first watch clasp according to an embodiment of this disclosure;

FIG. 16 is a schematic diagram of assembly of a lock clasp according to an embodiment of this disclosure;

FIG. 17 is a schematic diagram of an assembly process between a first watch clasp and a second watch clasp according to an embodiment of this disclosure;

FIG. 18 is a schematic diagram of a disassembly process between a first watch clasp and a second watch clasp according to an embodiment of this disclosure;

FIG. 19 is an exploded view of a first watch clasp and a second watch clasp according to an embodiment of this disclosure;

FIG. 20 is a schematic diagram of a structure of a watch according to an embodiment of this disclosure; and

FIG. 21 is a front view of a watch according to an embodiment of this disclosure.

Reference numerals: 1: First watch clasp; 11: First housing; 111: Boss; 112: Groove; 113: Sealing groove; 114: Positioning pin; 12: First cover; 121: Positioning opening; 13: Sealing component; 14: Lock clasp; 141: First sliding block; 142: First lock arm; 143: First notch; 144: Drive block; 145: Second sliding block; 146: Second lock arm; 147: Second notch; 15: First elastic component; 16: Second elastic component; 17: First magnetic component; 2: Second watch clasp; 21: Lock slot; 211: First protrusion; 212: First inclined surface; 213: Second inclined surface; 214: Second protrusion; 215: Third inclined surface; 216: Fourth inclined surface; 22: Second magnetic component; 23: Positioning hole; 3: First band body; 31: Flexible printed circuit; 4: Second band body; A: Accommodating space; 100: Watch face; 200: Watchband; 300: Electronic device.

### DESCRIPTION OF EMBODIMENTS

Terms used in embodiments of this disclosure are merely used to explain specific embodiments of this disclosure, but are not intended to limit this disclosure.

A smartwatch is an electronic watch. In addition to a timing function of other watches, the smartwatch has a plurality of other functions, such as communication, navigation, and body monitoring.

In a related technology, the smartwatch mainly includes a watch face and a watchband. An electronic device is disposed in the watch face, to implement various functions of the smartwatch. The watchband is connected to the watch face, so that the smartwatch can be bound to a wrist of a user. Currently, there are mainly two forms of watchbands. A body of a first watchband is a metal hinge. One end of the metal hinge is locked or unlocked by using a butterfly clasp. A body of a second watchband is a nylon band. One end of the nylon band is locked or unlocked by using a hook and loop fastener.

However, functions of the foregoing two watchbands are very simple, and only a function of binding the smartwatch to the wrist of the user is provided. This is not conducive to function extension of the smartwatch.

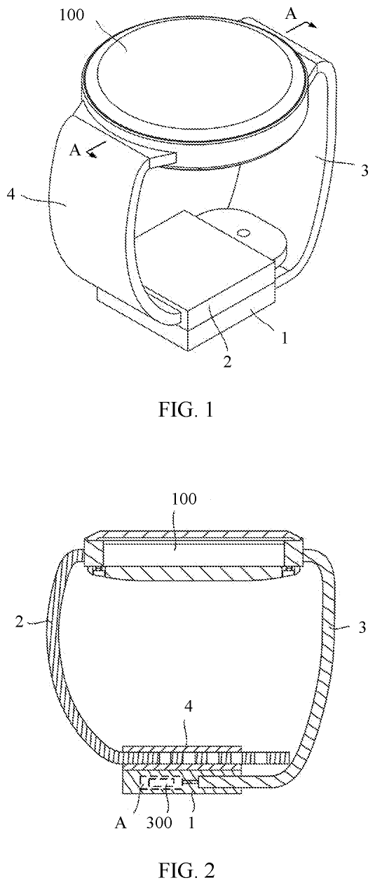

To resolve the foregoing technical problem, an embodiment of this disclosure provides a watchband. FIG. 1 is a schematic diagram of a structure of the watchband. The watchband includes a first watch clasp 1, a second watch clasp 2, a first band body 3, and a second band body 4.

FIG. 2 is a sectional view of FIG. 1 in a direction A-A. With reference to FIG. 2, an accommodating space A is provided in the first watch clasp 1, and the accommodating space A is used to accommodate an electronic device 300. The second watch clasp 2 is detachably connected to the first watch clasp 1. One end of the first band body 3 is connected to the first watch clasp 1, and is configured to be electrically connected to the electronic device 300. One end of the second band body 4 is connected to the second watch clasp 2.

The watchband is used in a watch. Because the accommodating space A is provided in the first watch clasp 1, various electronic devices 300 can be configured in the accommodating space A, to extend a function of the watch, so that functionality of the watch is improved.

It can be learned from the foregoing that, the watchband provided in this embodiment of this disclosure is conducive to function extension of a smartwatch because the accommodating space A is provided in the first watch clasp 1, and the accommodating space A can accommodate the electronic device 300 with various functions. The following describes a composition manner of the accommodating space A.

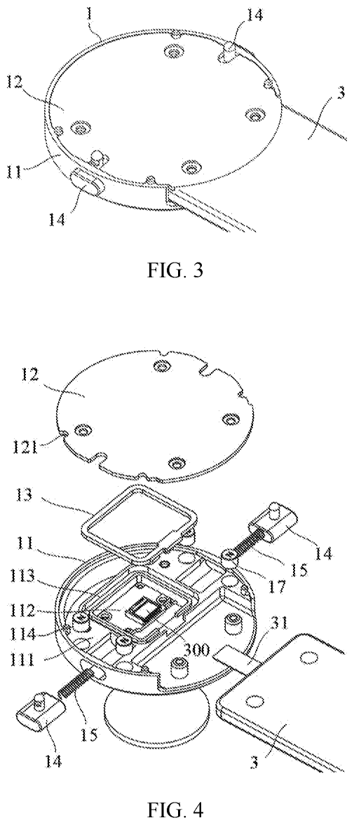

FIG. 3 is a schematic diagram of a structure of the first watch clasp 1. FIG. 4 is an exploded view of the first watch clasp 1. With reference to FIG. 3 and FIG. 4, in this embodiment, the first watch clasp 1 includes a first housing 11 and a first cover 12.

The first housing 11 is an open housing-shaped mechanical component. A boss 111 is disposed on an inner bottom surface of the first housing 11. A top of the boss 111 faces an opening of the first housing 11. A groove 112 is provided on a part that is of the boss 111 and that is away from the inner bottom surface of the first housing 11, that is, the groove 112 is located on the top of the boss 111. The first cover 12 is located at the opening of the first housing 11. The first cover 12 is connected to the boss 111, and covers a groove opening of the groove 112, to form the accommodating space A between the first cover 12 and the groove 112.

In the foregoing implementation, the accommodating space A is formed by covering the first cover 12 on the groove opening of the groove 112. The accommodating space A is located between the first cover 12 and the first housing 11. When the electronic device 300 is disposed in the accommodating space A, the electronic device 300 is first disposed in the groove 112 on the top of the boss 111, so that the electronic device 300 is electrically connected to the first band body 3. Then, the first cover 12 covers the groove opening of the groove 112, and the first cover 12 is connected to the boss 111, so that the electronic device 300 is enclosed in the accommodating space A.

Optionally, to ensure accurate assembly between the first cover 12 and the boss 111, a plurality of positioning pins 114 are disposed on the part that is of the boss 111 and that is away from the inner bottom surface of the first housing 11. The plurality of positioning pins 114 are arranged at an interval along an outer edge of the boss 111. A plurality of positioning openings 121 are provided on an outer edge of the first cover 12. The positioning openings 121 are in a one-to-one correspondence with the positioning pins 114. During assembly, the first cover 12 first covers the opening of the first housing 11, and it is ensured that all positioning pins 114 are inserted into the corresponding positioning openings 121. In this case, the first cover 12 does not shake unnecessarily under positioning of the positioning pins 114. Then, the first cover 12 is connected to the boss 111 through a part like a screw.

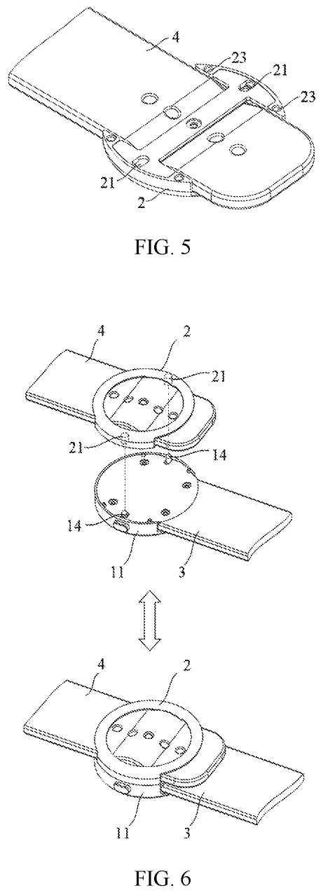

In addition, the positioning pin 114 can further implement positioning with the second watch clasp 2. FIG. 5 is a rear view of the second watch clasp. A back side of the second watch clasp is a side that faces the first watch clasp 1. A plurality of positioning holes 23 are provided on an outer wall of the second watch clasp 2. The plurality of positioning holes 23 are arranged at an interval along an outer edge of the second watch clasp 2, and are in a one-to-one correspondence with the positioning pins 114. After the first housing 11 and the first cover 12 are assembled together, one end that is of the positioning pin 114 and that is away from the boss 111 passes through the first cover 12. After the first watch clasp 1 and the second watch clasp 2 are connected together, the positioning pins 114 can be inserted into the corresponding positioning holes 23, avoiding unnecessary shaking between the first watch clasp 1 and the second watch clasp 2.

To ensure a service life of the electronic device 300, dustproof and waterproof processing is performed on the electronic device 300. Referring again to FIG. 4, a sealing groove 113 is provided around the groove 112. The sealing groove 113 is located at the part that is of the boss 111 and that is away from the inner bottom surface of the first housing 11, namely, the top of the boss 111. The first watch clasp 1 further includes a sealing component 13. The sealing component 13 is located in the sealing groove 113, and is clamped between the first cover 12 and the boss 111.

In this design, a gap between the first cover 12 and the boss 111 can be sealed through the sealing component 13, to avoid an impact on the electronic device 300 in the accommodating space A caused by dust, liquid, or the like entering the accommodating space A.

For example, the sealing component 13 is a rubber component. When the first cover 12 is connected to the boss 111, the first cover 12 also covers the sealing groove 113. Because the sealing component 13 has specific elasticity, the sealing component 13 is compressed in a space between the sealing groove 113 and the first cover 12, to reliably seal the accommodating space A.

Optionally, because the electronic device 300 in the accommodating space A is to be electrically connected to the first band body 3, the first band body 3 extends into the accommodating space A. Therefore, there is a notch at each of an edge of the groove 112 and an edge of the sealing groove 113, and the notch of the groove 112 faces the notch of the sealing groove 113. A flexible printed circuit (FPC) 31 is disposed in the first band body 3. One end of the flexible printed circuit 31 sequentially passes through the notch of the sealing groove 113 and the notch of the groove 112, and is inserted into the accommodating space A, to be electrically connected to the electronic device 300. The other end of the flexible printed circuit 31 is buried in the first band body 3, and extends along a length direction of the first band body 3, to be electrically connected to a watch face 100. To seal the notch of the groove 112 and the notch of the sealing groove 113, parts that are of the sealing component 13 and that correspond to the two notches fit the two notches. In this way, the two notches can be filled, to achieve sealing effect.

It can be learned from the foregoing that the first watch clasp 1 is detachably connected to the second watch clasp 2. Because the accommodating space A is provided in the first watch clasp 1, and occupies some spaces of the first watch clasp 1, other connection manners are not applicable to the watchband in this embodiment of this disclosure. To resolve the foregoing technical problem, an embodiment of this disclosure provides a detachable connection manner between the first watch clasp 1 and the second watch clasp 2. This is described below.

FIG. 6 is a schematic diagram of a disassembled state and an assembled state between the first watch clasp 1 and the second watch clasp 2. With reference to FIG. 6, in this embodiment, the first watch clasp 1 further includes a lock clasp 14. The lock clasp 14 is connected to the first housing 11 and can move relative to the first housing 11, and the lock clasp 14 is located on one side of the boss 111. A lock slot 21 is provided on the outer wall of the second watch clasp 2. A part that is of the lock clasp 14 and that is away from the first housing 11 is inserted into the lock slot 21, so that the lock clasp 14 and the lock slot 21 are locked or unlocked.

In the foregoing implementation, the first housing 11 provides an assembly basis for a first part of the lock clasp 14. Therefore, the first part of the lock clasp 14 can move relative to the first housing 11. To be specific, a second part of the lock clasp 14 can move relative to the first housing 11 together with the first part. In addition, because the lock clasp 14 is located on one side of the boss 111, the lock clasp 14 does not interfere with the boss 111, that is, does not affect the accommodating space A located on the top of the boss 111. When the lock clasp 14 is inserted into the lock slot 21, the lock clasp 14 and the lock slot 21 can be mutually locked or unlocked by moving the second part of the lock clasp 14. In other words, the lock clasp 14 is disposed on the first watch clasp 1, and the lock slot 21 is provided on the second watch clasp 2. A detachable connection between the first clasp and the second watch clasp 2 is implemented through fitting between the lock clasp 14 and the lock slot 21.

In this embodiment, two fitting manners between the lock clasp 14 and the lock slot 21 are provided. The following separately describes the two fitting manners.

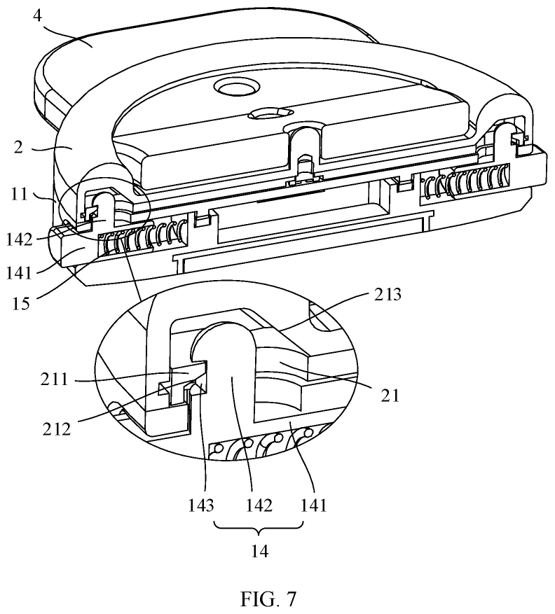

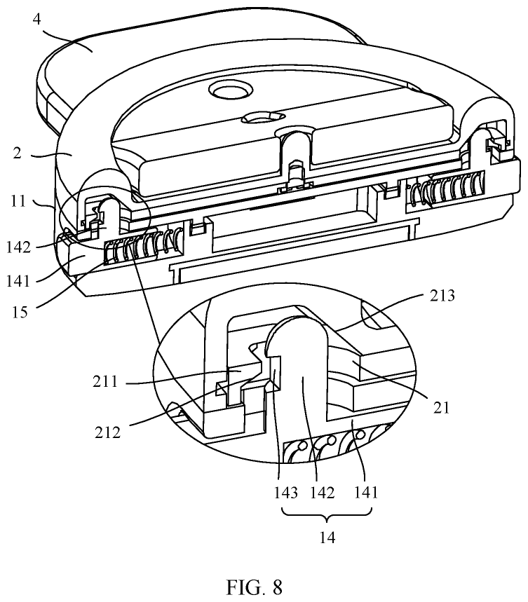

FIG. 6 mentioned above is the first fitting manner between the lock clasp 14 and the lock slot 21. FIG. 7 is a schematic diagram of a locked state between the lock clasp 14 and the lock slot 21 in this fitting manner. FIG. 8 is a schematic diagram of an unlocked state between the lock clasp 14 and the lock slot 21 in this fitting manner.

With reference to FIG. 7 and FIG. 8, in this embodiment, the second part of the lock clasp 14 is located between an edge part and a central part of the second watch clasp 2. When the second part of the lock clasp 14 is located at a first position in the lock slot 21, the second part of the lock clasp 14 is close to the edge part of the second watch clasp 2, and the second part of the lock clasp 14 and the lock slot 21 are mutually locked. When the second part of the lock clasp 14 is located at a second position in the lock slot 21, the second part of the lock clasp 14 is close to the central part of the second watch clasp 2, and the second part of the lock clasp 14 and the lock slot 21 are mutually unlocked.

To be specific, in this fitting manner of the lock clasp 14 and the lock slot 21, when a user operates the lock clasp 14, if the lock clasp 14 and the lock slot 21 are to be locked, the lock clasp 14 moves toward the edge part of the second watch clasp 2; or if the lock clasp 14 and the lock slot 21 are to be unlocked, the lock clasp 14 moves toward the central part of the second watch clasp 2. In this way, the lock clasp 14 and the lock slot 21 are locked or unlocked.

For example, in this embodiment, the second watch clasp 2 is circular. In this case, the edge part of the second watch clasp 2 is a part close to an edge of the circle, and the central part of the second watch clasp 2 is a part close to a center of the circle. In another embodiment, the second watch clasp 2 is square. In this case, the edge part of the second watch clasp 2 is a part close to an edge of the square, and the central part of the second watch clasp 2 is a part close to a diagonal intersection point of the square. It is easy to understand that the shape of the second watch clasp 2 is merely used as an example, and the shape of the second watch clasp 2 is not limited in this disclosure.

It should be noted that, in a process of fitting the first watch clasp 1 and the second watch clasp 2, in a horizontal direction (in a plane direction in which the first watch clasp 1 is fastened to the second watch clasp 2), the edge part of the second watch clasp 2 corresponds an edge part of the first watch clasp 1, namely, a position away from the boss 111. The central part of the second watch clasp 2 corresponds a central part of the first watch clasp 1, namely, a position close to the boss 111. In other words, when the second part of the lock clasp 14 is located at the first position in the lock slot 21, the first part of the lock clasp 14 is correspondingly located at a first position in the first housing 11. When the second part of the lock clasp 14 is located at the second position in the lock slot 21, the second part of the lock clasp 14 is correspondingly located at a second position in the first housing 11. In addition, in a process in which the second part of the lock clasp 14 moves between the first position and the second position, the first part of the lock clasp 14 moves between an edge part of the first housing 11 and the boss 111. In this case, the lock clasp 14 does not interfere with the boss 111 and does not affect the accommodating space A located on the top of the boss 111.

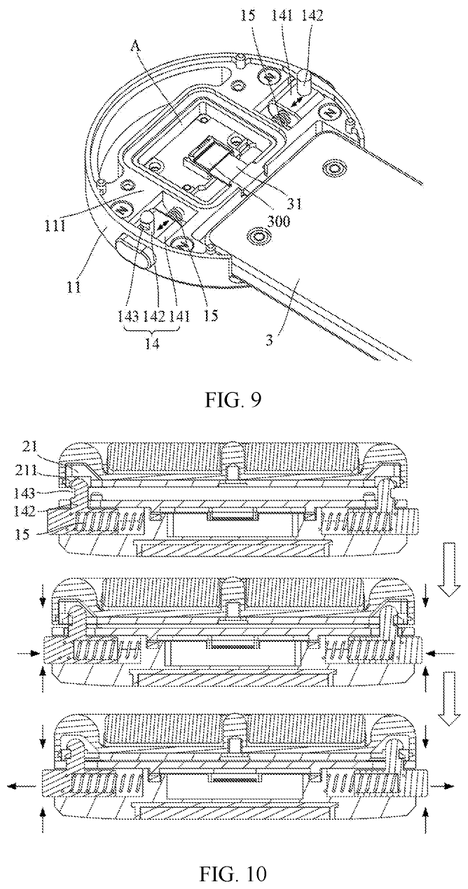

FIG. 9 is a schematic diagram of assembly of the lock clasp 14. A solid arrow in FIG. 9 is a moving direction of the lock clasp 14. With reference to FIG. 9, in this embodiment, the lock clasp 14 includes a first sliding block 141 and a first lock arm 142. A first part of the first sliding block 141 is located in the first housing 11, a second part of the first sliding block 141 is located outside the first housing 11, and the first sliding block 141 can move relative to the first housing 11. A first part of the first lock arm 142 is connected to the first part of the first sliding block 141, and is located on a side that is of the first sliding block 141 and that is away from the inner bottom surface of the first housing 11, a second part of the first lock arm 142 is located outside the first housing 11, and a first notch 143 is provided on a side wall of the second part of the first lock arm 142.

Because the second part of the first sliding block 141 is located outside the first housing 11, the user can drive, by moving the second part of the first sliding block 141, the first part of the first sliding block 141 located in the first housing 11 to move. In addition, because the first end of the first lock arm 142 is connected to the first part of the first sliding block 141, the first lock arm 142 also moves together in a process of moving the first sliding block 141.

With reference to FIG. 7 and FIG. 8, a first protrusion 211 is provided on an inner side wall of the lock slot 21, the first protrusion 211 is located at a slot opening of the lock slot 21, and the first protrusion 211 faces the first notch 143.

When the first sliding block 141 drives the second part of the first lock arm 142 to move away from the center of the second watch clasp 2, and the first protrusion 211 is located in the first notch 143, the lock clasp 14 and the lock slot 21 are mutually locked. When the first sliding block 141 drives the second part of the first lock arm 142 to move toward the center of the second watch clasp 2, and the first protrusion 211 is located outside the first notch 143, the lock clasp 14 and the lock slot 21 are mutually unlocked.

It should be noted that, with reference to FIG. 7 and FIG. 8, when the first protrusion 211 is inserted into the first notch 143, the lock clasp 14 and the lock slot 21 are locked. This means that the lock clasp 14 cannot be directly pulled out of the lock slot 21 in a direction from a slot bottom of the lock slot 21 to the slot opening. When the first protrusion 211 is located outside the first notch 143, the lock clasp 14 and the lock slot 21 are unlocked. This means that the lock clasp 14 can be directly pulled out of the lock slot 21 in the direction from the slot bottom of the lock slot 21 to the slot opening.

Still with reference to FIG. 7 and FIG. 8, to make the process of inserting the lock clasp 14 into the lock slot 21 smoother, in this embodiment, a first inclined surface 212 is provided on a side that is of the first protrusion 211 and that is close to the slot opening of the lock slot 21. In a direction toward the center of the second watch clasp 2, the first inclined surface 212 tilts from the slot opening of the lock slot 21 to the slot bottom. In this design, in the process of inserting the lock clasp 14 into the lock slot 21, a top of the lock clasp 14 abuts against the first inclined surface 212, and moves from the first position to the second position along the first inclined surface 212, to avoid the first protrusion 211. In this way, the lock clasp 14 is gradually inserted into the lock slot 21, and the process of inserting the lock clasp 14 into the lock slot 21 is smoother.

Correspondingly, to make the process of pulling the lock clasp 14 out of the lock slot 21 smoother, a second inclined surface 213 is further provided on the inner side wall of the lock slot 21. The second inclined surface 213 faces the first inclined surface 212. In the direction toward the center of the second watch clasp 2, the second inclined surface 213 tilts from the slot bottom of the lock slot 21 to the slot opening. In this design, in the process of pulling the lock clasp 14 out of the lock slot 21, the lock clasp 14 moves from the first position to the second position, so that the top of the lock clasp 14 abuts against the second inclined surface 213. The lock clasp 14 is pushed out of the lock slot 21 under an action of the second inclined surface 213, so that the process of pulling the lock clasp 14 out of the lock slot 21 is smoother.

Still with reference to FIG. 7 and FIG. 8, to ensure that the lock clasp 14 can be securely locked in the lock slot 21, in this embodiment, the first watch clasp 1 further includes a first elastic component 15. The first elastic component 15 is located in the first housing 11, and is compressed between the second part of the lock clasp 14 and the boss 111. An elastic direction of the first elastic component 15 is the same as the moving direction of the lock clasp 14. In other words, the first elastic component 15 can apply one acting force to move the lock clasp 14 toward the first position.

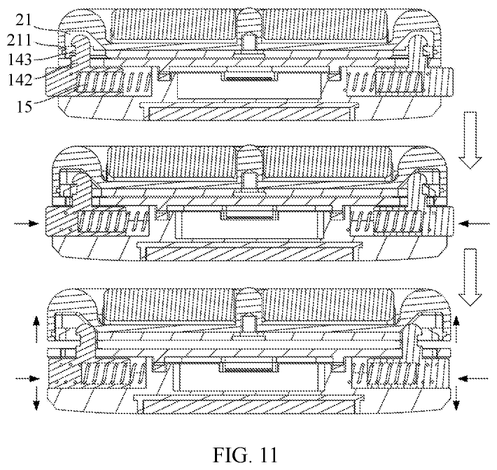

FIG. 10 is a schematic diagram of an assembly process between the first watch clasp 1 and the second watch clasp 2. A hollow arrow means an assembly sequence, and a solid arrow means a moving direction of a component. FIG. 11 is a schematic diagram of a disassembly process between the first watch clasp 1 and the second watch clasp 2. A hollow arrow means an assembly sequence, and a solid arrow mean the moving direction of the component. With reference to FIG. 10 and FIG. 11, the following describes the assembly process and disassembly process between the first watch clasp 1 and the second watch clasp 2 under an action of the first elastic component 15.

When the lock clasp 14 is in an initial state (the lock clasp 14 and the lock slot 21 are unlocked), the lock clasp 14 is located at the first position under the action of the first elastic component 15 (refer to an upper view in FIG. 10). In the process of inserting the lock clasp 14 into the lock slot 21, the top of the first lock arm 142 abuts against the first inclined surface 212. Under an action of the first inclined surface 212, the lock clasp 14 moves from the first position to the second position, and compresses the first elastic component 15, to avoid the first protrusion 211 (refer to a middle view in FIG. 10). After the first protrusion 211 is avoided, elastic potential energy of the first elastic component 15 is released, to drive the lock clasp 14 from the second position to the first position. In this case, the first protrusion 211 is inserted into the first notch 143, so that the lock clasp 14 and the lock slot 21 are locked (refer to a lower view in FIG. 10).

When the lock clasp 14 is in an initial state (the lock clasp 14 and the lock slot 21 are locked), the lock clasp 14 is located at the first position under the action of the first elastic component 15 (refer to an upper view in FIG. 11). In the process of pulling the lock clasp 14 out of the lock slot 21, the lock clasp 14 moves from the first position to the second position, and compresses the first elastic component 15 until the top of the first lock arm 142 abuts against the second inclined surface 213 (refer to a middle view in FIG. 11). Under the action of the second inclined surface 213, the lock clasp 14 is gradually pushed out of the lock slot 21, so that the lock clasp 14 and the lock slot 21 are unlocked (refer to a lower view in FIG. 11). After the lock slot 21 is pulled out of the lock slot 21, the elastic potential energy of the first elastic component 15 is released, to drive the lock clasp 14 from the second position to the first position. In this case, the lock clasp 14 is reset, to wait for a next locking operation.

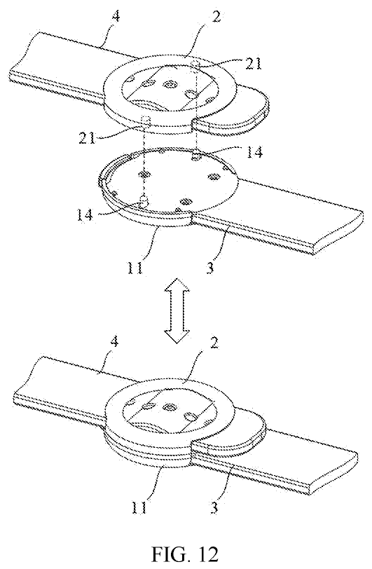

FIG. 12 is the second fitting manner between the lock clasp 14 and the lock slot 21. Similarly, the lock clasp 14 is inserted into the lock slot 21, so that the lock clasp 14 and the lock slot 21 are locked. The lock clasp 14 is pulled out of the lock slot 21, so that the lock clasp 14 and the lock slot 21 are unlocked. Main differences lie in different driving manners for the lock clasp 14, and different positions of a first position and a second position. This is described below.

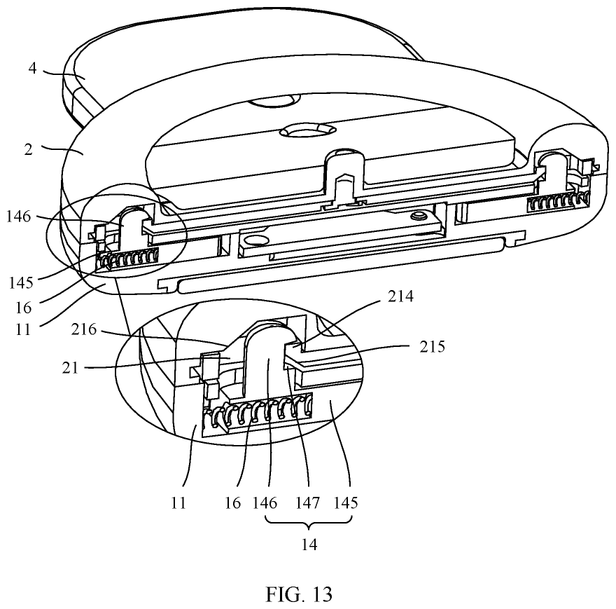

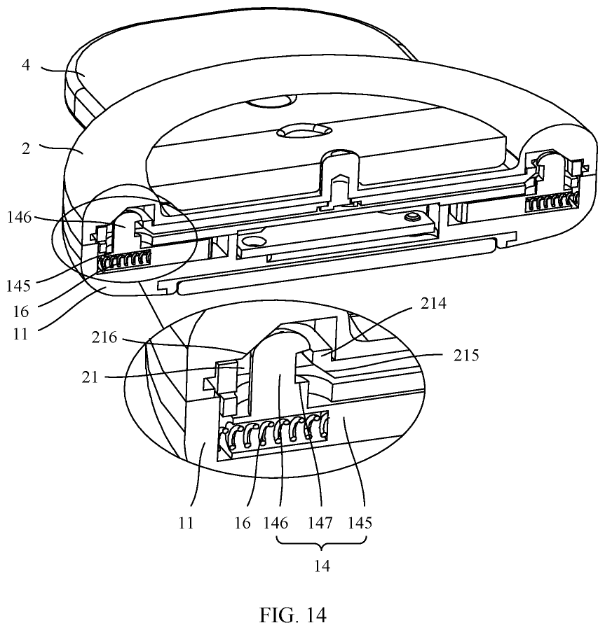

FIG. 13 is a schematic diagram of a locked state between the lock clasp 14 and the lock slot 21 in this fitting manner. FIG. 14 is a schematic diagram of an unlocked state between the lock clasp 14 and the lock slot 21 in this fitting manner.

With reference to FIG. 13 and FIG. 14, in this embodiment, a second part of the lock clasp 14 is located between an edge part and a central part of the second watch clasp 2. When the second part of the lock clasp 14 is located at a first position in the lock slot 21, the second part of the lock clasp 14 is close to the central part of the second watch clasp 2, and the second part of the lock clasp 14 and the lock slot 21 are mutually locked. When the second part of the lock clasp 14 is located at a second position in the lock slot 21, the second part of the lock clasp 14 is close to the edge part of the second watch clasp 2, and the second part of the lock clasp 14 and the lock slot 21 are mutually unlocked.

To be specific, in this fitting manner of the lock clasp 14 and the lock slot 21, when a user operates the lock clasp 14, if the lock clasp 14 and the lock slot 21 are to be locked, the lock clasp 14 moves toward the central part of the second watch clasp 2, or if the lock clasp 14 and the lock slot 21 are to be unlocked, the lock clasp 14 moves toward the edge part of the second watch clasp 2. In this way, the lock clasp 14 and the lock slot 21 are locked or unlocked.

In addition, in a process in which the second part of the lock clasp 14 moves between the first position and the second position, a first part of the lock clasp 14 moves between an edge part of a first housing 11 and a boss 111. In this case, the lock clasp 14 does not interfere with the boss 111 and does not affect an accommodating space A located on a top of the boss 111.

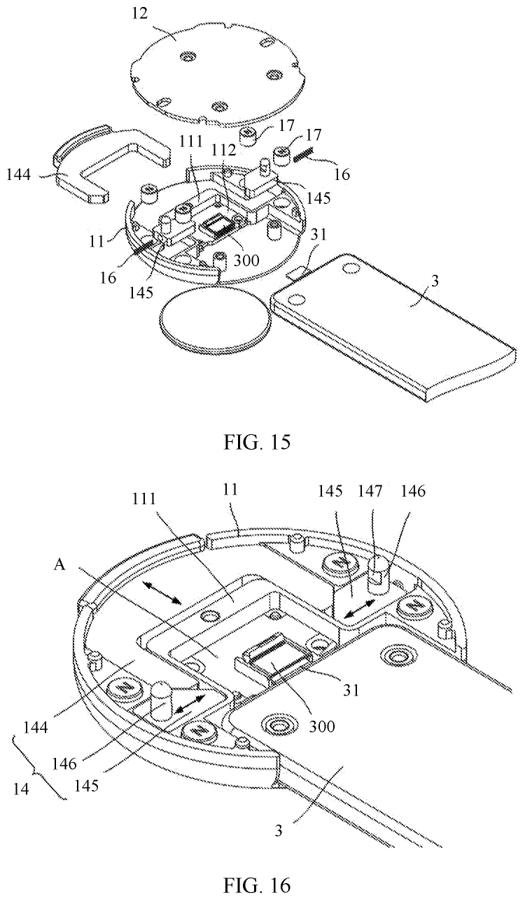

FIG. 15 is an exploded view of the first watch clasp 1. FIG. 16 is a schematic diagram of assembly of the lock clasp 14. A solid arrow in FIG. 16 is a moving direction of the lock clasp 14. With reference to FIG. 15 and FIG. 16, in this embodiment, the lock clasp 14 includes a drive block 144, a second sliding block 145, and a second lock arm 146. A first part of the drive block 144 is located in the first housing 11, a second part of the drive block 144 is located outside the first housing 11, and the drive block 144 can move relative to the first housing 11. The second sliding block 145 is movably inserted into the first housing 11, and is in sliding contact with the drive block 144. An included angle exists between the moving direction of the second sliding block 145 and a moving direction of the drive block 144. A first part of the second lock arm 146 is connected to a first part of the second sliding block 145, and is located on a side that is of the second sliding block 145 and that is away from an inner bottom surface of the first housing 11. A second part of the second lock arm 146 is located outside the first housing 11, and a second notch 147 is provided on a side wall of the second part of the second lock arm 146.

Because the second part of the drive block 144 is located outside the first housing 11, the user can drive, by moving the second part of the drive block 144, the first part of the drive block 144 located in the first housing 11 to move. In addition, the first part of the drive block 144 is in contact with the second sliding block 145, and the second lock arm 146 is connected to the second sliding block 145. Therefore, the second lock arm 146 also moves together in a process of moving the drive block 144.

In the foregoing implementation, there is an extrusion inclined surface on a side of the moving direction of the drive block 144. An included angle of 45° exists between the extrusion inclined surface and the moving direction of the drive block 144. There is an extrusion inclined surface on a side of the moving direction of the second sliding block 145. An included angle of 45° exists between the extrusion inclined surface and the moving direction of the second sliding block 145. The extrusion inclined surface of the drive block 144 slidably fits with the extrusion inclined surface of the second sliding block 145. When the drive block 144 moves, under an action of the two extrusion inclined surfaces, a part of acting force, applied by the drive block 144 to the second sliding block 145, changes to a component force perpendicular to the moving direction of the drive block 144. The component force can drive the second sliding block 145 to move along the moving direction perpendicular to the drive block 144.

With reference to FIG. 13 and FIG. 14, a second protrusion 214 is provided on an inner side wall of the lock slot 21. The second protrusion 214 is located at a slot opening of the lock slot 21, and the second protrusion 214 faces the second notch 147.

When the drive block 144 drives the second sliding block 145 to move the second part of the second lock arm 146 toward a center of the second watch clasp 2, and the second protrusion 214 is located in the second notch 147, the lock clasp 14 and the lock slot 21 are mutually locked. When the second sliding block 145 drives the second part of the second lock arm 146 to move away from the center of the second watch clasp 2, and the second protrusion 214 is located outside the second notch 147, the lock clasp 14 and the lock slot 21 are mutually unlocked.

Still with reference to FIG. 13 and FIG. 14, to make the process of inserting the lock clasp 14 into the lock slot 21 smoother, in this embodiment, a third inclined surface 215 is provided on a side that is of the second protrusion 214 and that is close to the slot opening of the lock slot 21. In a direction away from the center of the second watch clasp 2, the third inclined surface 215 tilts from the slot opening of the lock slot 21 to a slot bottom. In this design, in the process of inserting the lock clasp 14 into the lock slot 21, a top of the lock clasp 14 abuts against the third inclined surface 215, and moves from the first position to the second position along the third inclined surface 215, to avoid the second protrusion 214. In this way, the lock clasp 14 is gradually inserted into the lock slot 21, and the process of inserting the lock clasp 14 into the lock slot 21 is smoother.

Correspondingly, to make the process of pulling the lock clasp 14 out of the lock slot 21 smoother, a fourth inclined surface 216 is further provided on the inner side wall of the lock slot 21. The fourth inclined surface 216 faces the third inclined surface 215. In the direction away from the center of the second watch clasp 2, the fourth inclined surface 216 tilts from the slot bottom of the lock slot 21 to the slot opening. In this design, in the process of pulling the lock clasp 14 out of the lock slot 21, the lock clasp 14 moves from the first position to the second position, so that the top of the lock clasp 14 abuts against the fourth inclined surface 216. The lock clasp 14 is pushed out of the lock slot 21 under an action of the fourth inclined surface 216, so that the process of pulling the lock clasp 14 out of the lock slot 21 is smoother.

Still with reference to FIG. 13 and FIG. 14, to ensure that the lock clasp 14 can be securely locked in the lock slot 21, in this embodiment, the first watch clasp 1 further includes a second elastic component 16.

The second elastic component 16 is located in the first housing 11, and is compressed between the second part of the lock clasp 14 and an inner side wall of the first housing 11. An elastic direction of the second elastic component 16 is the same as the moving direction of the lock clasp 14. In other words, the second elastic component 16 can apply one acting force to move the lock clasp 14 toward the first position.

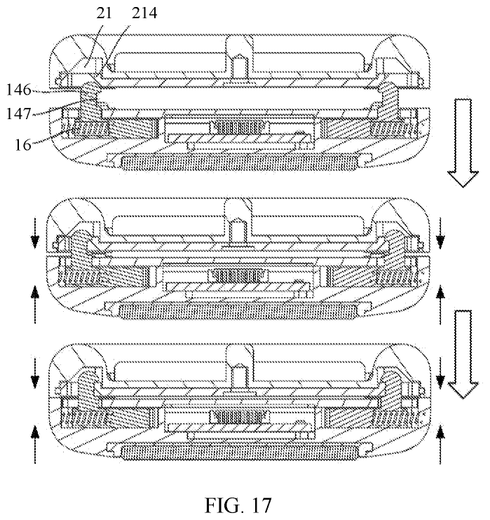

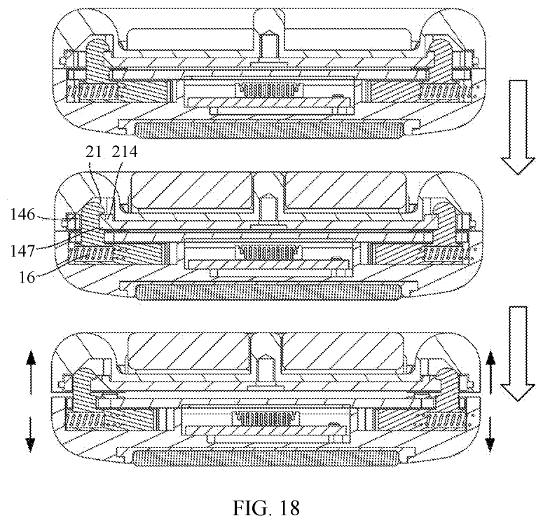

FIG. 17 is a schematic diagram of an assembly process between the first watch clasp 1 and the second watch clasp 2. A hollow arrow means an assembly sequence, and a solid arrow means a moving direction of a component. FIG. 18 is a schematic diagram of a disassembly process between the first watch clasp 1 and the second watch clasp 2. A hollow arrow means an assembly sequence, and a solid arrow mean the moving direction of the component. With reference to FIG. 17 and FIG. 18, the following describes the assembly process and disassembly process between the first watch clasp 1 and the second watch clasp 2 under an action of the second elastic component 16.

When the lock clasp 14 is in an initial state (the lock clasp 14 and the lock slot 21 are unlocked), the lock clasp 14 is located at the first position under the action of the second elastic component 16 (refer to an upper view in FIG. 17). In the process of inserting the lock clasp 14 into the lock slot 21, the top of the second lock arm 146 abuts against the third inclined surface 215. Under an action of the third inclined surface 215, the lock clasp 14 moves from the first position to the second position, and compresses the second elastic component 16, to avoid the second protrusion 214 (refer to a middle view in FIG. 17). After the second protrusion 214 is avoided, elastic potential energy of the second elastic component 16 is released, to drive the lock clasp 14 from the second position to the first position. In this case, the second protrusion 214 is inserted into the second notch 147, so that the lock clasp 14 and the lock slot 21 are locked (refer to a lower view in FIG. 17).

When the lock clasp 14 is in an initial state (the lock clasp 14 and the lock slot 21 are locked), the lock clasp 14 is located at the first position under the action of the second elastic component 16 (refer to an upper view in FIG. 18). In the process of pulling the lock clasp 14 out of the lock slot 21, the lock clasp 14 moves from the first position to the second position, and compresses the second elastic component 16 until the top of the second lock arm 146 abuts against the fourth inclined surface 216 (refer to a middle view in FIG. 18). Under the action of the fourth inclined surface 216, the lock clasp 14 is gradually pushed out of the lock slot 21, so that the lock clasp 14 and the lock slot 21 are unlocked (refer to a lower view in FIG. 18). After the lock slot 21 is pulled out of the lock slot 21, the elastic potential energy of the second elastic component 16 is released, to drive the lock clasp 14 from the second position to the first position. In this case, the lock clasp 14 is reset, to wait for a next locking operation.

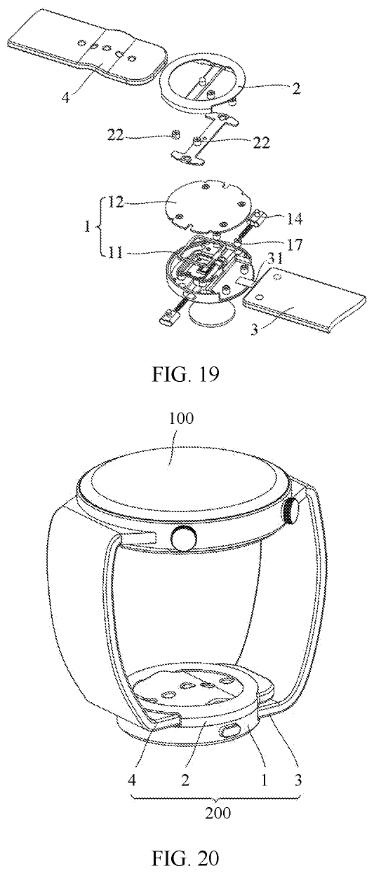

FIG. 19 is an exploded view of the first watch clasp 1 and the second watch clasp 2. With reference to FIG. 19, in this embodiment, a first magnetic component 17 is disposed in the first watch clasp 1. A second magnetic component 22 is disposed in the second watch clasp 2, and the second magnetic component 22 and the first magnetic component 17 are attracted to each other. In this design, when the first watch clasp 1 is fastened to the second watch clasp 2, the first magnetic component 17 and the second magnetic component 22 are attracted to each other. Under effect of this magnetic force, the first watch clasp 1 and the second watch clasp 2 automatically move toward each other, and are mutually locked through fitting between the lock clasp 14 and the lock slot 21.

FIG. 20 is a schematic diagram of a structure of a watch according to an embodiment of this disclosure. Refer to FIG. 20. The watch is a smartwatch, and includes a watch face 100, a watchband 200, and an electronic device 300.

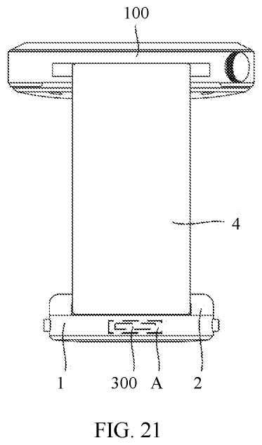

The watchband 200 is the watchband shown in FIG. 1 to FIG. 19. One end of a first band body 3 that is away from a first watch clasp 1 is connected to the watch face 100. One end of a second band body 4 that is away from a second watch clasp 2 is connected to the watch face 100. The electronic device 300 is located in an accommodating space A (refer to FIG. 21), and is electrically connected to the watch face 100 through the first band body.

Because various electronic devices 300 can be accommodated in the first watch clasp 1 of the watchband 200, the watch can correspondingly have a plurality of different functions based on different electronic devices 300, to extend the function of the watch, so that functionality of the watch is improved.

In the foregoing specific implementations, the objectives, technical solutions, and beneficial effect of this disclosure are further described in detail. It should be understood that the foregoing descriptions are merely the specific implementations of this disclosure, but are not intended to limit the protection scope of this disclosure. Any modification, equivalent replacement, improvement, or the like made based on the technical solutions of this disclosure shall fall within the protection scope of this disclosure.

What is claimed is:

1. An apparatus, comprising:
a first watch clasp comprising an accommodating space, wherein the accommodating space is configured to accommodate an electronic device;
a second watch clasp detachably connected to the first watch clasp;
a first band body comprising a first end connected to the first watch clasp and configured to be electrically connected to the electronic device; and
a second band body comprising a second end connected to the second watch clasp.

2. The apparatus of claim 1, wherein the first watch clasp comprises:
a first housing;
a first cover;
a boss disposed on an inner bottom surface of the first housing; and
a groove comprising a groove opening and disposed on a first part of the boss that is away from the inner bottom surface,
wherein the first cover is connected to the boss and is configured to cover the groove opening to form the accommodating space between the first cover and the groove.

3. The apparatus of claim 2, further comprising:
a sealing groove around the groove; and
a sealing component located in the sealing groove and clamped between the first cover and the boss.

4. The apparatus of claim 2, wherein the first watch clasp further comprises:
a lock clasp located on a first side of the boss, connected to the first housing, and configured to move relative to the first housing;
a lock slot on an outer wall of the second watch clasp; and
a second part that is of the lock clasp, that is away from the first housing, and that is configured to be inserted into the lock slot to lock or unlock the lock clasp and the lock slot.

5. The apparatus of claim 4, wherein the lock clasp comprises:
a first sliding block comprising:
a third part located in the first housing; and
a fourth part located outside the first housing,
wherein the first sliding block is configured to move relative to the first housing;
a first lock arm comprising:
a fifth part connected to the third part, located on a second side of the first sliding block, and located away from the inner bottom surface;
a sixth part located outside the first housing; and
a first notch on a side wall of the sixth part; and
a first protrusion on an inner side wall of the lock slot, located at a slot opening of the lock slot, and facing the first notch,
wherein the lock clasp and the lock slot are configured to mutually lock when the first sliding block drives the sixth part to move away from a center of the second watch clasp and the first protrusion is located in the first notch, and
wherein the lock clasp and the lock slot are configured to mutually unlock when the first sliding block drives the sixth part to move toward the center and the first protrusion is located outside the first notch.

6. The apparatus of claim 5, further comprising:
a first inclined surface on a third side of the first protrusion, wherein in a direction toward the center, the first inclined surface is configured to tilt from the slot opening to a slot bottom; and
a second inclined surface on the inner side wall and facing the first inclined surface,
wherein in the direction toward the center, the second inclined surface is configured to tilt from the slot bottom to the slot opening.

7. The apparatus of claim 5, wherein the first watch clasp further comprises a first elastic component located in the first housing and compressed between a seventh part of the lock clasp and the boss, and wherein an elastic direction of the first elastic component is the same as a moving direction of the lock clasp.

8. The apparatus of claim 4, wherein the lock clasp comprises:
a drive block comprising:
a third part located in the first housing; and
a fourth part located outside the first housing,
wherein the drive block is configured to move relative to the first housing;
a second sliding block movably inserted into the first housing and in sliding contact with the drive block, wherein the second sliding block is configured to move in a first moving direction, and wherein the drive block is configured to move in a second moving direction that forms an included angle with the first moving direction;
a second lock arm comprising:
a fifth part connected to a sixth part of the second sliding block and located on a second side of the second sliding block away from the inner bottom surface;
a seventh part located outside the first housing; and
a second notch on a side wall of the seventh part; and
a second protrusion on a first inner side wall of the lock slot, located at a slot opening of the lock slot, and facing the second notch,
wherein the lock clasp and the lock slot are configured to mutually lock when the drive block drives the second sliding block to move the seventh part toward a center of the second watch clasp, and the second protrusion is located in the second notch, and
wherein the lock clasp and the lock slot are configured to mutually unlock when the second sliding block drives the seventh part to move away from the center, and the second protrusion is located outside the second notch.

9. The apparatus of claim 8, further comprising:
a third inclined surface on a third side of the second protrusion, wherein in a direction away from the center, the third inclined surface is configured to tilt from the slot opening to a slot bottom; and
a fourth inclined surface on the first inner side wall and facing the third inclined surface,
wherein in the direction away from the center, the fourth inclined surface is configured to tilt from the slot bottom to the slot opening.

10. The apparatus of claim 9, wherein the first watch clasp further comprises a second elastic component located in the first housing and compressed between an eighth part of the lock clasp and a second inner side wall of the first housing, and wherein an elastic direction of the second elastic component is the same as a third moving direction of the lock clasp.

11. The apparatus of claim 1, wherein the first watch clasp includes a first magnetic component, wherein the second watch clasp includes a second magnetic component, and wherein the second magnetic component and the first magnetic component are attracted to each other.

12. An apparatus, comprising:
a watch face;
a watchband comprising:
a first watch clasp comprising an accommodating space;
a second watch clasp detachably connected to the first watch clasp;
a first band body having a first end connected to the first watch clasp and a second end connected to the watch face; and
a second band body having a third end connected to the second watch clasp and a fourth end connected to the watch face; and
an electronic device located in the accommodating space and electrically connected to the watch face through the first end.

13. The apparatus of claim 12, wherein the first watch clasp comprises:
a first housing comprising:
a boss on an inner bottom surface; and
a groove comprising a groove opening and on a first part of the boss that is away from the inner bottom surface; and
a first cover coupled to the boss and configured to cover the groove opening to form the accommodating space between the first cover and the groove.

14. The apparatus of claim 13, further comprising:
a sealing groove around the groove; and
a sealing component located in the sealing groove and clamped between the first cover and the boss.

15. The apparatus of claim 13, wherein the first watch clasp further comprises:
a lock clasp connected to the first housing, located on one side of the boss, and configured to move relative to the first housing; and
a lock slot on an outer wall of the second watch clasp, wherein a second part of the lock clasp is away from the first housing and is configured to be inserted into the lock slot to lock or unlock the lock clasp and the lock slot.

16. The apparatus of claim 15, wherein the lock clasp further comprises:
a first sliding block comprising:
a third part located in the first housing; and
a fourth part located outside the first housing,
wherein the first sliding block is configured to move relative to the first housing;
a first lock arm comprising:
a fifth part connected to the first part and located on a first side of the first sliding block away from the inner bottom surface;
a sixth part located outside the first housing; and
a first notch on a side wall of the sixth part; and
a first protrusion on an inner side wall of the lock slot, located at a slot opening of the lock slot, and facing the first notch,
wherein the lock clasp and the lock slot are mutually locked when the first sliding block drives the sixth part to move away from a center of the second watch clasp, and the first protrusion is located in the first notch, and
wherein the lock clasp and the lock slot are mutually unlocked when the first sliding block drives the sixth part to move toward the center, and the first protrusion is located outside the first notch.

17. The apparatus of claim 16, further comprising:
a first inclined surface on a second side of the first protrusion, wherein in a direction toward the center, the first inclined surface is configured to tilt from the slot opening to a slot bottom; and
a second inclined surface on the inner side wall and facing the first inclined surface,
wherein in the direction toward the center, the second inclined surface is configured to tilt from the slot bottom to the slot opening.

18. The apparatus of claim 15, wherein the lock clasp further comprises:
a drive block comprising:
a third part located in the first housing; and
a fourth part located outside the first housing,
wherein the drive block is configured to move relative to the first housing;
a second sliding block comprising:
a fifth part; and
a sixth part,
wherein the second sliding block is inserted into the first housing and is in sliding contact with the drive block, and
wherein the second sliding block is configured to move in a first moving direction, and wherein the drive block is configured to move in a second moving direction that forms an included angle with the first moving direction;
a second lock arm comprising:
a seventh part connected to the fifth part and located on a first side of the second sliding block that is away from the inner bottom surface;
an eighth part located outside the first housing; and
a second notch on a side wall of the eighth part; and
a second protrusion on an inner side wall of the lock slot, located at a slot opening of the lock slot, and facing the second notch,
wherein the lock clasp and the lock slot are mutually locked when the drive block drives the second sliding block to move the eighth part toward a center of the second watch clasp, and the second protrusion is located in the second notch, and
wherein the lock clasp and the lock slot are mutually unlocked when the second sliding block drives the eighth part to move away from the center, and the second protrusion is located outside the second notch.

19. The apparatus of claim 18, further comprising:
a third inclined surface on a second side of the second protrusion, wherein in a direction away from the center, the third inclined surface is configured to tilt from the slot opening to a slot bottom; and
a fourth inclined surface on the inner side wall, wherein the fourth inclined surface is facing the third inclined surface, and
wherein in the direction away from the center, the fourth inclined surface is configured to tilt from the slot bottom to the slot opening.

20. The apparatus of claim 12, wherein the first watch clasp includes a first magnetic component, wherein the second watch clasp includes a second magnetic component, and wherein the second magnetic component and the first magnetic component are attracted to each other.
